(19) United States
(12) Patent Application Publication
(10) Pub. No.: US 2026/0330128 A1
(43) Pub. Date: Oct. 22, 2026

(54) DYNAMIC AI-ASSISTED GUIDANCE FOR ELECTRONIC RECORD COMPLETION

(71) Applicant: Microsoft Technology Licensing, LLC, Redmond, WA (US)

(72) Inventors: Jerome TREMBLAY, Saguenay (CA); Sharmistha Sarkar GRAY, Dracut, MA (US); Eirik SOMERVILLE, Wellesley, MA (US); Howard Maurice D’SOUZA, Chantilly, VA (US)

(21) Appl. No.: 19/182,106

(22) Filed: Apr. 17, 2025

(51) Int. Cl. G06F 40/174; G06F 40/279

(52) U.S. Cl. CPC G06F 40/174; G06F 40/279

(57) ABSTRACT

An electronic record input system (ERIS) may detect historical entities in the electronic record, the historical entities corresponding to the context and corresponding to first input fields of the electronic record. The ERIS may identify a next input field of the electronic record based on the historical entities by executing a predictive model on the historical entities, wherein the next input field corresponds to a next entity in the context, the next input field is different from the first input fields. The ERIS may generate one or more suggested actions for guiding the collection of the next entity corresponding to the next input field by executing a generative artificial intelligence model on the next input field and the historical entities. The ERIS may present the one or more suggested actions using the user computing device.

### BACKGROUND

Electronic records are a critical component for professional interactions in various professions (e.g., nursing, policing, teaching, investigating, etc.). For example, medical professionals (e.g., nurses) maintain patient records as a critical component of patient care, providing a comprehensive record of the patient's health status, treatment, and progress. Such electronic records need to be constantly updated with the latest information about the patient. Electronic records may include a vast number of sections (e.g., flowsheets, tabs, etc.) and input fields that can be filled with information.

### SUMMARY

In some aspects, the techniques described herein relate to a computer-implemented method of guiding collection of information for input into an electronic record via a user computing device, the information corresponding to a context, the computer-implemented method including: detecting historical entities in the electronic record, the historical entities corresponding to the context and corresponding to first input fields of the electronic record; identifying a next input field of the electronic record based on the historical entities by executing a predictive model on the historical entities, wherein the next input field corresponds to a next entity in the context, the next input field is different from the first input fields; generating one or more suggested actions for guiding the collection of the next entity corresponding to the next input field by executing a generative artificial intelligence model on the next input field and the historical entities; and presenting the one or more suggested actions using the user computing device.

In some aspects, the techniques described herein relate to a system for guiding collection of information for input into an electronic record via a user computing device, the information corresponding to a context, the system including: one or more hardware processors; a memory; a record entity identifier storable in the memory, executable by the one or more hardware processors, and configured to perform operations including detecting historical entities in the electronic record, the historical entities corresponding to the context and corresponding to first input fields of the electronic record; and a next fields predictor storable in the memory, executable by the one or more hardware processors, and configured to perform operations including identifying a next input field of the electronic record based on the historical entities by executing a predictive model on the historical entities, wherein the next input field corresponds to a next entity in the context, the next input field is different from the first input fields; a feedback generator storable in the memory, executable by the one or more hardware processors, and configured to perform operations including: generating one or more suggested actions for guiding the collection of the next entity corresponding to the next input field by executing a generative artificial intelligence model on the next input field and the historical entities; and presenting the one or more suggested actions using the user computing device.

In some aspects, the techniques described herein relate to one or more tangible processor-readable storage media embodied with instructions for executing on one or more processors and circuits of a computing device a process for guiding collection of information for input into an electronic record via a user computing device, the information corresponding to a context, the process including: detecting historical entities in the electronic record, the historical entities corresponding to the context and corresponding to first input fields of the electronic record; identifying a next input field of the electronic record based on the historical entities by executing a predictive model on the historical entities, wherein the next input field corresponds to a next entity in the context, the next input field is different from the first input fields; generating one or more suggested actions for guiding the collection of the next entity corresponding to the next input field by executing a generative artificial intelligence model on the next input field and the historical entities; and presenting the one or more suggested actions using the user computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example computing environment for providing suggestive feedback to guide a professional in conducting a professional interaction between the professional and a subject to obtain information for input to an electronic record.

FIG. 2 illustrates an example user interface for selecting a guide for conducting a professional interaction to obtain information for input to an electronic record.

FIG. 3 illustrates an example user interface for displaying guidance for conducting a professional interaction to obtain information for input to an electronic record.

FIG. 4 illustrates examples of user interfaces and for displaying guidance for conducting a professional interaction to obtain information for input to an electronic record.

FIG. 5 illustrates an example computing environment for detecting record entities in a professional interaction for input to an electronic record.

FIG. 6 illustrates an example computing environment for predicting next fields of an electronic record based on contextual information including a topic selection.

FIG. 7 illustrates an example computing environment for determining record entity verification statuses for record entities detected during a professional interaction.

FIG. 8 illustrates an example computing environment for generating suggestive feedback for guiding a professional interaction.

FIG. 9 illustrates an example computing environment for entering verified record entities into an electronic record.

FIG. 10 depicts examples of operations for guiding collection of information for input into an electronic record via a user computing device.

FIG. 11 illustrates an example computing device for use in implementing the described technology.

### DETAILED DESCRIPTIONS

Electronic records may include a vast number of sections (e.g., flowsheets, tabs, etc.) and input fields that can be filled with information. Accordingly, not all of the fields of a document are relevant to a context (e.g., a series of medical consultations, an insurance claim, a criminal investigation), and the electronic record may be difficult to navigate to the appropriate fields that are relevant to the context and may present an information overload to the professional responsible for entering information into the electronic record. Further, having to manually navigate the electronic record while having a professional interaction (e.g., engaging in conversation, performing one or more tests, etc.) with a subject (e.g., a medical consultation/interview with a patient), which may be necessary due to time constraints, may be distractive or interruptive to the professional interaction, reducing the ability of the professional to focus on and fully engage in the professional interaction.

Also, a professional may need to update fields of an electronic record as the professional becomes apprised of new information that may be supplementary or even contradictory to historical information that was previously entered into the electronic record. Accordingly, conventional manual entering and updating of information into an electronic record requires significant and careful review by the professional, which may be difficult given time constraints.

The technology disclosed herein addresses the inadequacies of electronic record completion by providing artificial intelligence (AI) assisted guidance for entering information into an electronic record. The disclosed technology, in some implementations, may detect entities (e.g., terms in a transcript) of an ongoing activity (e.g., a conversation between a professional and a subject) that are relevant to fields of the electronic record and enter the entities into the fields. The disclosed technology may identify, during the activity, a next input field of the electronic record that is relevant to the context by executing a predictive model on contextual information, including historical entities entered into the electronic record, a profile of the subject or the professional, a selected subsection (e.g., a guide, a flowsheet) of the electronic record, or other contextual information. The disclosed technology can generate and display guidance, including suggested actions for the professional to obtain additional information to input to the next field. The guidance may also include a transcript of the activity (e.g., a transcript of the professional’s dictation or of the professional’s conversation with a subject) and highlight entities detected in the transcript that may be input into the electronic record or that contradict historical information that was already entered into the electronic record. In some implementations, the transcript is of a natural language input detected in an audio or video. The guidance provided by the disclosed technology reduces the burden and cognitive load that is required by professionals to conduct activities while inputting information into electronic records.

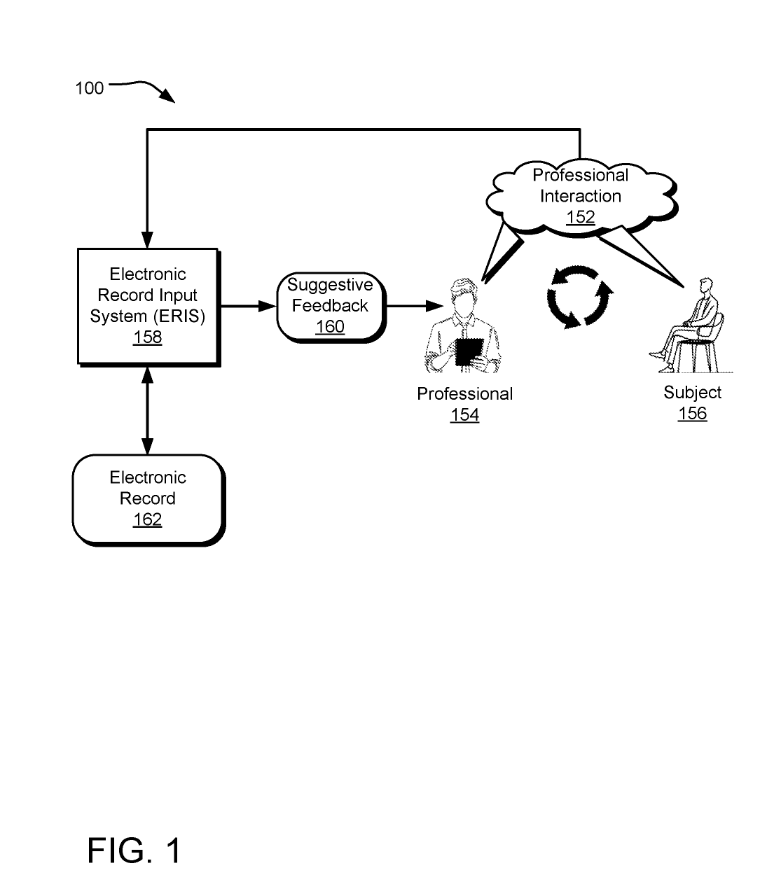

FIG. 1 illustrates an example computing environment 100 for providing suggestive feedback 160 to guide a professional 154 in conducting a professional interaction 152 between the professional 154 and a subject 156 to obtain information for input to an electronic record 162. The computing environment 100 includes an electronic record input system (ERIS) 158. The ERIS 158 may record a professional interaction between the professional 154 and one or more subjects (e.g., subject 156).

The ERIS 158 may capture (e.g., audio, video, sensor data, or other data from) and/or communicate with one or more other systems or devices that capture all or part of the professional interaction 152. In some implementations, the ERIS 158 operates on a user computing device, a tablet computing device, a smartphone computing device, a smartwatch computing device, a desktop computing device, or another computing device that is used by a professional 154. In some implementations, the ERIS 158 communicates (e.g., via a network) with an application of a computing device of the professional 154 to display suggestive feedback 160 to the professional 154.

The professional interaction 152 involves a professional 154 and, in some implementations, one or more subjects (e.g., subject 156). The professional 154 may be a nurse, a doctor, a court reporter, a detective, an adjuster, an analyst, or other professional 154. The professional 154 may conduct the professional interaction 152 with a subject 156, for example, a patient, a witness, a suspect, a claimant, a study participant, or other subject 156. The professional interaction 152 may be a medical consultation, an interview, or other professional interaction between the professional 154 and the subject 156. In some implementations, the professional interaction 152 involves, wholly or in part, only the professional 154 and does not involve a subject 156. For example, the professional interaction 152 is, wholly or in part, a dictation, monologue, or other activity involving only activities of the professional 154. The professional interaction 152 (e.g., a medical consultation, an audit interview, an inspection, etc.) may be part of a broader context (e.g., a hospital stay, an audit, an insurance claim, etc.) that may involve multiple professional interactions.

The ERIS 158 may access an electronic record 162. The electronic record 162 is a structured digital record designed to store and manage information. The electronic record 162 may be divided into different sections (e.g., tabs, flowsheets, pages, etc.). Each section of the electronic record may include input fields supporting various types of input. For example, the input fields may include but are not limited to, free-text fields for entering text, dropdown menus for selection of standardized options, checkboxes and radio buttons for selection/confirmation of specific information, date and time fields, numeric input fields, and document upload fields for attachment of images, portable document format (PDF) documents, or other documents or inclusion of information (e.g., a link, a web address, a file path, etc.) for accessing such documents from a specified location.

The ERIS 158 may input entities detected in (e.g., detected in a recording of, a video of, sensor data of, or other captured data of) the professional interaction 152 into applicable fields of the electronic record 162. For example, the ERIS 158 may generate an event capture (e.g., one or more of a transcript of recorded audio, frames of captured video, detected sensor readings, etc.) of the professional interaction 152, detect entities of the event capture applicable to fields of the electronic record 162 (e.g., using an entity detection algorithm or entity detection machine learning model), and enter one or more of the detected entities into the applicable fields of the electronic record 162. The transcript may be a transcript of natural language input in the event capture.

The ERIS 158 provides suggestive feedback 160 to the professional 154 based on contextual information including one or more of the fields of the electronic record 162, predicted next fields of the electronic record 162 (e.g., output by a predictive model), record entities detected in the event capture (e.g., transcript) of the professional interaction 152, previous record entities entered into one or more fields of the electronic record 162, a profile of the subject 156, a profile of the professional 154, a profile of an institution (e.g., a hospital) for which the professional 154 works, or other contextual information. The suggestive feedback 160 may include one or more of questions, suggested actions, or other feedback that advises the professional 154 concerning conducting the professional interaction 152 to obtain additional information for entry into the electronic record 162. In some implementations, the suggestive feedback 160 includes feedback advising the professional 154 concerning obtaining additional information for entry into the predicted next fields of the electronic record 162.

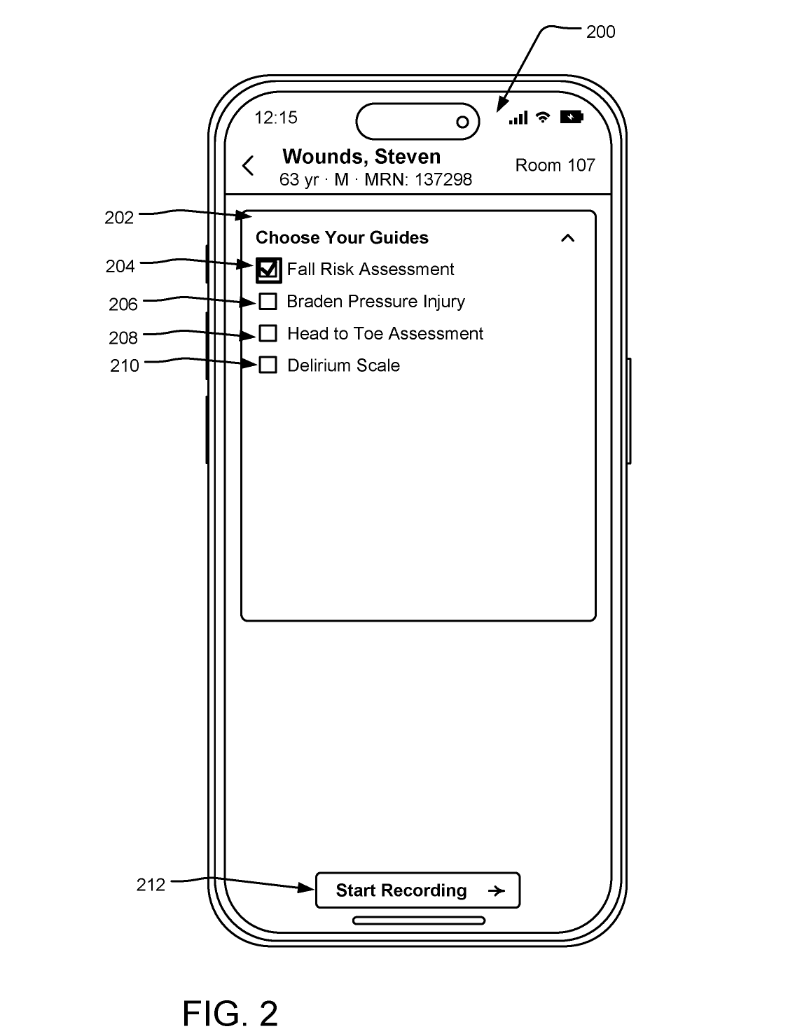

FIG. 2 illustrates an example user interface 200 for selecting a guide for conducting a professional interaction to obtain information for input to an electronic record. The user interface 200 presents a “Choose Your Guides” screen 202 that includes checkbox object 204, checkbox object 206, checkbox object 208, and checkbox object 210, each checkbox object corresponding to a respective guide of a set of four guides. Each guide is a subset of fields of an electronic record. The subset of fields may correspond to a topic of a set of topics, where each topic corresponds to a different subset of fields of the electronic record. The subset of fields may correspond to a respective section (e.g., a flowsheet, a tab, etc.) of the electronic record, where each section of the sections of the electronic record includes a different subset of fields of the electronic record.

An ERIS may generate the user interface 200 and display (e.g., via a user computing device of the professional) the user interface 200. A professional conducting a professional interaction with a subject (e.g., a nurse conducting a medical evaluation with a patient) may select one or more of the selectable guides. In the example user interface 200 of FIG. 2, the “Fall Risk Assessment” guide is selected, as indicated by the checked checkbox object 204. The checkbox object 206 corresponding to the “Braden Pressure Injury” guide, the checkbox object 208 corresponding to the “Head to Toe Assessment” guide, and the checkbox object 210 corresponding to the “Delirium Scale” guide are all unchecked. The user interface 200 further presents, among other information, the name of the subject (“Wounds, Steven”), age information, and room information in an upper portion of the user interface 200.

The user interface 200 includes a “Start Recording” interface object 212 that, responsive to selection, initiates recording (e.g., audio, video, sensor data in an environment of the professional and/or the subject, as applicable) of a professional interaction. The professional interaction includes the professional and, in some implementations, the subject. For example, an ERIS receives the selection of the guide, and the ERIS captures the data from the recording. The selection of the guide (e.g., corresponding to a subset of fields of the electronic record) may provide contextual data for a predictive model to predict one or more next fields of the electronic record that are relevant to the professional interaction (e.g., or to a context involving one or more previous professional interactions and the professional interaction).

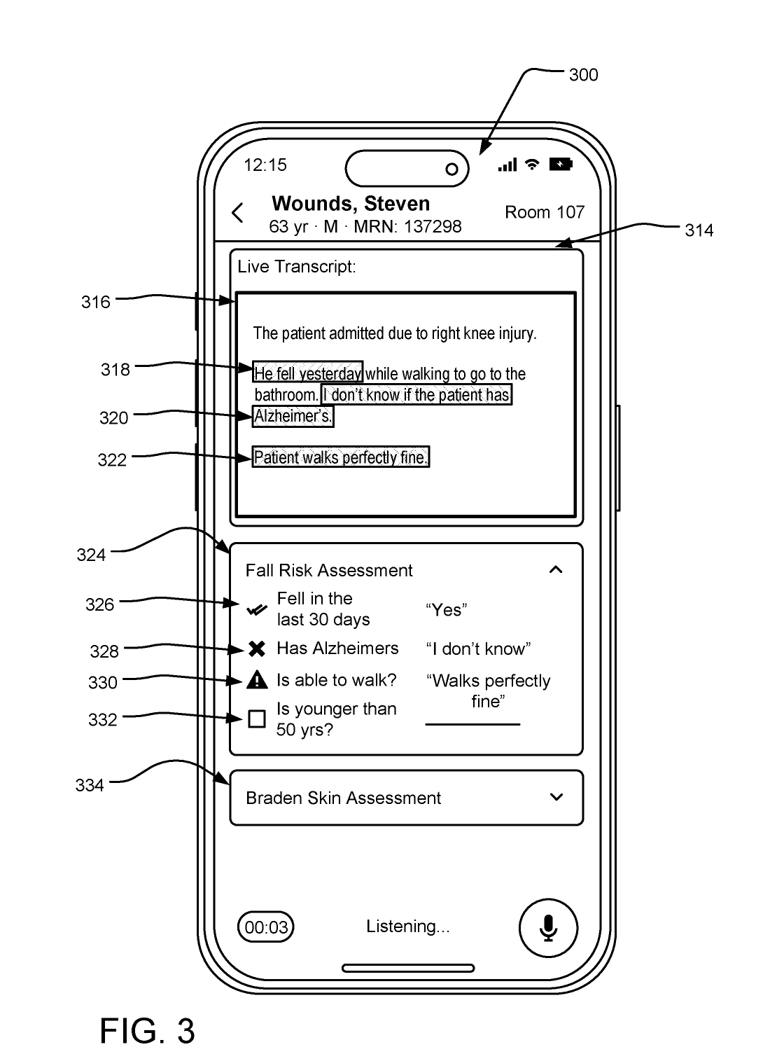

FIG. 3 illustrates an example user interface 300 for displaying guidance for conducting a professional interaction to obtain information for input to an electronic record. A professional conducting a professional interaction with a subject (e.g., a nurse conducting a medical evaluation with a patient) may view the user interface 300 during the interaction and obtain suggestive feedback for conducting the professional interaction.

An ERIS may generate the user interface 300 for display via a computing device of the professional. The example user interface 300 presents suggestive feedback to assist the professional in conducting the professional interaction to obtain information for an electronic record. In some implementations, the professional views the user interface 300 responsive to selecting the guide and selecting the “start recording” object in the user interface 200 of FIG. 2.

The suggestive feedback may include a transcript interface 314, a guide-specific electronic record fields interface 324, and a guide-specific electronic record fields interface 334. The transcript interface 314 includes a live transcript 316 that includes a text of the ongoing professional interaction captured (e.g., via audio recording) between the professional and the subject. The transcript interface 314 indicates, within the live transcript 316, entities detected within the live transcript that correspond to fields of the electronic record. For example, entity 318, entity 320, and entity 322 are detected in the live transcript 316. Each of the detected entities represents inputs that are enterable (e.g., able to be input) into corresponding fields of the electronic record. The transcript interface 314 may indicate a verification status for each of the detected entities. The guide-specific electronic record fields interface 324 presents the entities detected in the live transcript 316 that are relevant to a guide selected by the professional (e.g., the “Fall Risk Assessment” guide selected in the user interface 200 of FIG. 2).

Entity 318 is indicated with a box having bottom-left-to-top-right diagonal crosshatching in the transcript interface 314, indicating that entity 318 is a “verified” type entity. In the example depicted in FIG. 3, entity 318 reads, “He fell yesterday.” The entity 318 detected in the live transcript 316 is also presented as element 326 of the guide-specific electronic record fields interface 324. The double checkmark indicates the “verified entity” type. A description of the corresponding field in the electronic record (“Fell in the last 30 days”), as well as a value (“Yes”) to be entered into the electronic record in accordance with the detected entity 318, are displayed in element 326. A verified entity is an entity detected in the live transcript 316 that corresponds to a field in the electronic record and indicates an input to the electronic record of a data type (e.g., “Yes” of yes/no options) supported by the field.

Entity 320 is indicated with a box having top-left-to-bottom-right diagonal crosshatching in the transcript interface 314 that indicates that entity 320 is a “missing information” type entity. The entity 320 detected in the live transcript 316 is also presented as element 328 of the guide-specific electronic record fields interface 324. The “x” mark indicates the “missing information” type. A description of the corresponding field in the electronic record (“Has Alzheimer’s”), as well as a value (“I don’t know”) to be entered into the electronic record in accordance with the detected entity 320, are displayed in element 328. For example, a missing information entity is detected in the transcript that is relevant to a field in the electronic record but for which information has not yet been given. For example, entity 320 reads “I don’t know if the patient has Alzheimer’s” and is relevant to a checkbox field in the electronic record that enables one to either check one of three checkboxes reading “Yes,” “No,” or “I don’t know” to indicate a field reading “Has Alzheimer’s.” However, as indicated in the live transcript 316, the wording of entity 320 indicates that the speaker has provided information that indicates an entry of a check into the “I don’t know” checkbox of the electronic record. Accordingly, the entity 320 is a missing information entity. In another example, if information regarding a pain level is missing (e.g., an answer in the electronic record corresponding to pain level is blank), the entity is highlighted as unverified. This may suggest to the professional that a follow-up question asking the subject to indicate a pain level. In some implementations, a confirmation of the missing entity is solicited from the professional requesting the professional to confirm that the entity is a missing entity.

Entity 322 is indicated in the transcript interface 314 with a box having double diagonal crosshatching that indicates that the entity 322 is a “contradicting” type entity. The entity 322 detected in the live transcript 316 is also presented as element 330 of the guide-specific electronic record fields interface 324. The “missing information” type is indicated by the caution triangle mark. A description of the corresponding field in the electronic record (“Is able to walk?”), as well as a value (“Walks perfectly fine”) to be entered into the electronic record in accordance with the detected entity 322, are displayed in element 330. A contradicting entity is an entity detected in the live transcript 316 that may be input to a field of an electronic record, but that has a value that contradicts a previous value entered into the field and/or a previous entity detected in the live transcript 316. For example, the entity detected in the live transcript 316 is “Patient walks perfectly fine” but entity 318 (“He fell yesterday”) may contradict the entity 322 indicating that the patient walks perfectly fine. In another example, an entity of “32 years old” is detected in the live transcript 316 but the previous value entered into a corresponding “age” field of the electronic record is “30” or a previous entity detected in the live transcript 316 that reads “He’s 31 years old.” In some instances, the contradicting entity is an entity that may be input to a field of the electronic record but that has a value that contradicts other values entered into one or more other fields of the electronic record other than the corresponding field. For example, the entity detected in the live transcript 316 is “32 years old” but a “child under 18” checkbox of the electronic record is checked, presenting a contradiction between the detected entity and previous information entered into the electronic record.

A “relevant” type entity is an entity that is not detected in the live transcript 316 but that is relevant to a field of an electronic record corresponding to the selected guide. Relevant type entities are not displayed in the live transcript 316 because they have not been detected in the live transcript but they are displayed in the guide-specific electronic record fields interface 324. Relevant type entities may indicate fields that are important to fill as a result of the interaction between the professional and the subject. For example, the element 332 of the guide-specific electronic record fields interface 324 displays a relevant type entity of a patient’s age being or not being less than 50 years old, corresponding to a field of “Is younger than 50yrs?” of the electronic record. Element 332 indicates the relevant type entity using the box icon in element 332, displays a title/description of the field of the electronic record (“Is younger than 50yrs?”), and indicates that an entity has not been detected in the live transcript 316 with a line (“___________”).

The example user interface 300 displays another guide-specific electronic record fields interface 334, which upon selection, may display further elements indicating entities, corresponding entity verification statuses, corresponding electronic record field names, and corresponding data to be entered (or not entered) to the corresponding fields, similarly to the guide-specific electronic record fields interface 324. The guide-specific electronic record fields interface 334 will list entities corresponding to fields in the “Braden Skin Assessment,” which may be selected in the user interface 200 of FIG. 2.

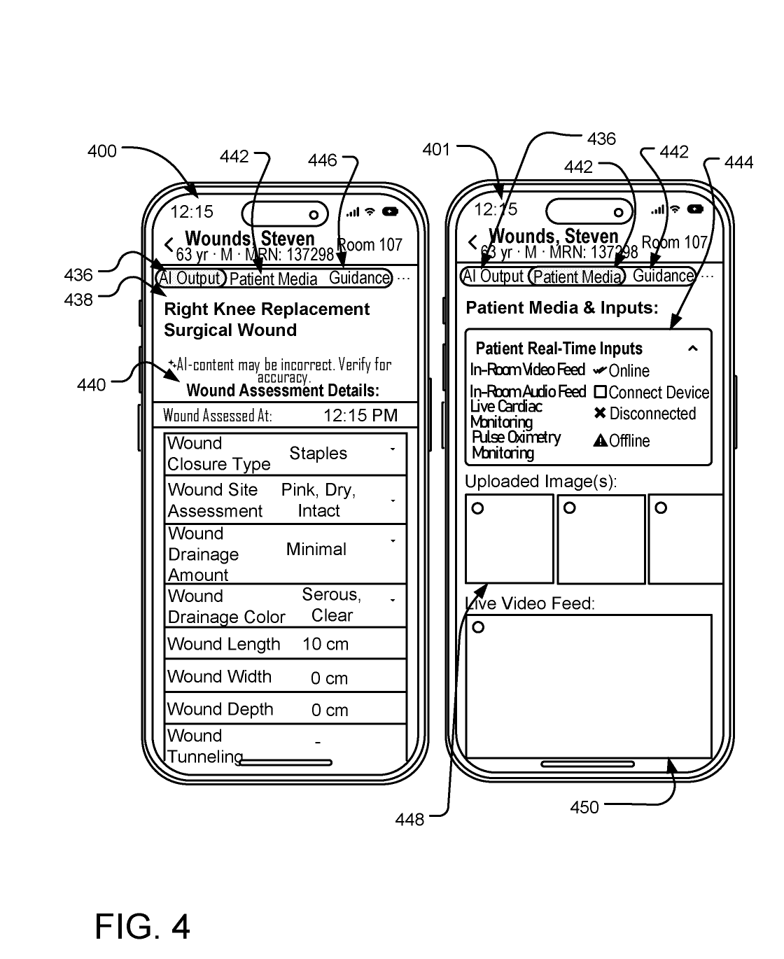

FIG. 4 illustrates examples of user interfaces 400 and 401 for displaying guidance for conducting a professional interaction to obtain information for input to an electronic record. An ERIS may generate one or more of the user interface 400 and the user interface 401 for display via a computing device of the professional. The examples of user interface 400 and user interface 401 present suggestive feedback for the professional to assist the professional in conducting the professional interaction to obtain information for an electronic record. In some implementations, the professional may toggle between the user interface 300 of FIG. 3, user interface 400, and/or the user interface 401 responsive to selecting the guide and selecting the “start recording” object in the user interface 200 of FIG. 2.

The user interface 400 presents an “AI output” summary. The user interface 400 includes tab 436, which reads “AI Output,” and which is shaded, indicating that a display of the user interface 400 is currently selected. The user interface includes tab 442, which reads “Patient Media” and, upon selection, displays user interface 401 and includes tab 446, which reads “Guidance,” and, upon selection, displays user interface 300 of FIG. 3. Accordingly, the professional can navigate between the three user interfaces (e.g., user interface 400, user interface 401, user interface 300) using the three tabs.

The user interface 400 presents information relevant to a guide (e.g., a section, a flowsheet) of an electronic record in a guide-specific section 438 of the user interface 400 (which reads “Right Knee Replacement Surgical Wound”). Within the guide-specific section 438, the example user interface 400 presents a subsection 440 that describes “Wound Assessment Details” that summarizes information gathered from a professional interaction between the professional and the patient. The information may be gathered from a live transcript, video, sensor, or other data sources and may be output by a machine learning model. The information may include fields of the electronic record and corresponding values entered into the fields, entered in the format “Field Name: Value.” For example, the subsection 440 displays details “Wound Closure Type: Staples,” “Wound Site Assessment: Pink, Dry, Intact,” “Wound Drainage Amount: Minimal,” “Wound Drainage Color: Serous, Clear,” Wound Length: 10 cm,” “Wound Width: 0 cm,” “Wound Depth: 0 cm,” and “Wound Tunnelling: -.”

The user interface 401 presents a “Patient Media” interface. The user interface 401 includes tab 442, which reads “Patient Media,” and which is shaded, indicating that a display of the user interface 401 is currently selected. The user interface includes tab 436, which reads “AI Output” and, upon selection, displays user interface 400 and includes tab 446, which reads “Guidance,” and, upon selection, displays user interface 300 of FIG. 3. Accordingly, the professional can navigate, similarly to user interface 400, between the three user interfaces (e.g., user interface 401, user interface 400, user interface 300) using the three tabs.

The user interface 401 presents an input device status feed 444, which presents the status of each of a set of input devices from which the ERIS may receive data during a professional interaction of the professional. For example, the input device status feed 444 presents a status for each of the “In-Room Video Feed,” “In-Room Audio Feed,” “Live Cardiac Monitoring,” and “Pulse Oximetry Monitoring,” input feeds, the corresponding indicated statuses of which are “Online,” “Connect Device,” “Disconnected,” and “Offline,” of each input feed respectively. The user interface 401 displays a set of uploaded images 448 and a data feed object 450. The data feed object 450 in the example user interface 401 displays data received from the In-Room Video Feed Device. In some implementations, the professional may provide input to the data feed object 450 so that input data from one of a set of input feeds (e.g., In-Room Audio feed, Live Cardiac Monitoring, or Pulse Oximetry Monitoring).

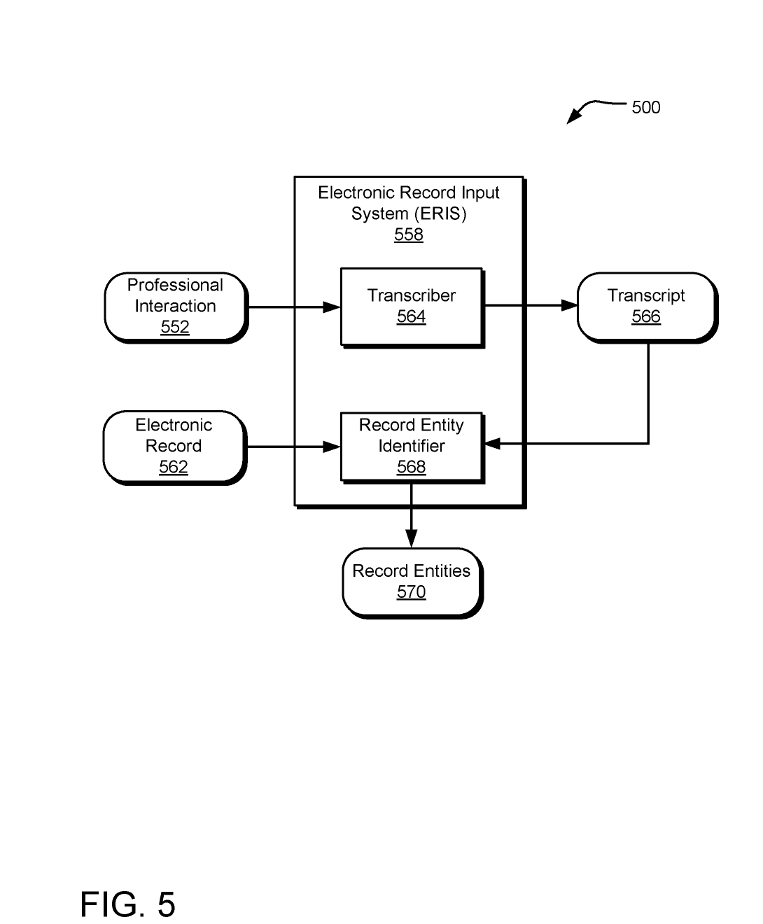

FIG. 5 illustrates an example computing environment 500 for detecting record entities 570 in a professional interaction 552 for input to an electronic record. The computing environment 500 includes an ERIS 558. The ERIS 558 includes a transcriber 564 and a record entity identifier 568.

The transcriber 564 generates a transcript 566 of the professional interaction 552. The transcript 566 may be a transcript of an audio feed or recording of the professional interaction 552. For example, the transcriber 564 applies a transcription algorithm to detect words uttered during the professional interaction 552 in the audio feed or audio recording and generate the transcribed text including the detected words. In some implementations, the transcript 566 includes objects detected in a video feed. For example, the transcriber 564 applies an object detection algorithm to a video feed of the professional interaction 552. In some implementations, the transcript 566 includes sensor data, for example, a recorded temperature, a blood pressure, a heart rate, or other sensor data from one or more sensors used during the professional interaction 552. For example, the ERIS 558 communicates with one or more of an audio recording device, a video recording device, or sensor instruments (e.g., thermometers, blood pressure cuffs, heart rate monitors) to receive one or more of an audio feed, a video feed, or sensor data during the professional interaction 552.

The record entity identifier 568 detects, extracts, or otherwise identifies record entities 570 in the transcript 566. Record entities 570 are entities that correspond to values that may be input to fields of the electronic record. The record entity identifier 568 may apply a named entity recognition (NER) algorithm or other algorithm to identify the record entities 570 in the transcript 566 based on one or more of the fields or the values that are able to be entered into the fields of the electronic record 562.

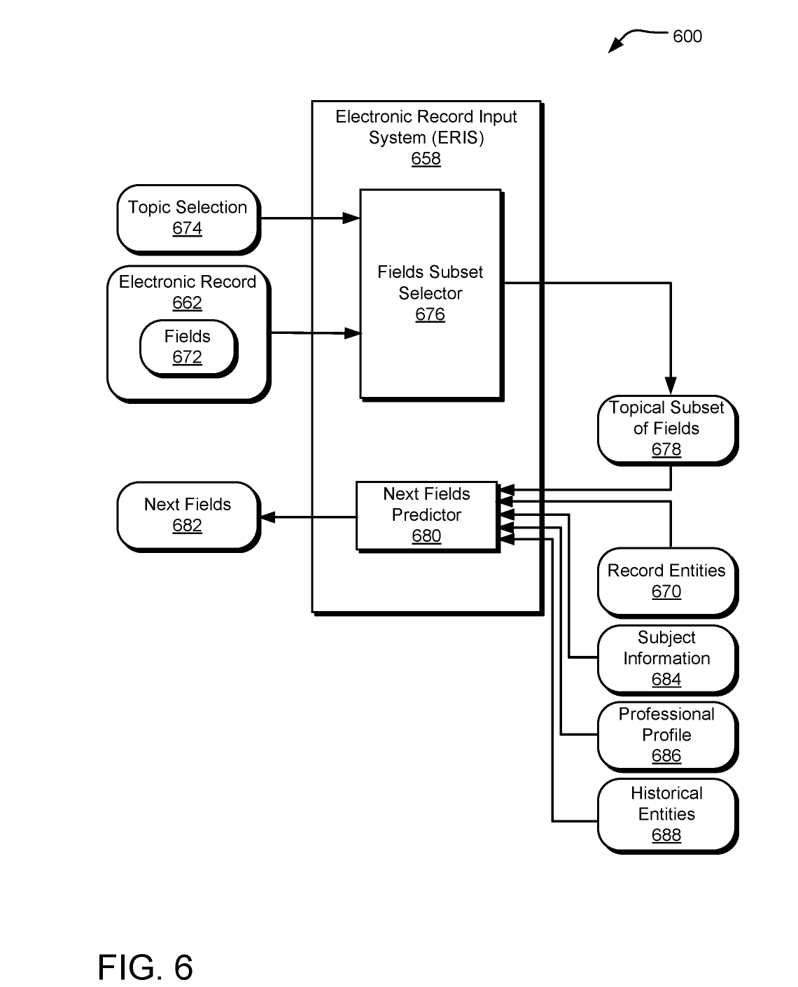

FIG. 6 illustrates an example computing environment 600 for predicting next fields 682 of an electronic record 662 based on contextual information including a topic selection. The computing environment 600 includes an ERIS 658. The ERIS 658 includes a fields subset selector 676 and a next fields predictor 680.

The fields subset selector 676 selects a topical subset of fields 678 of the fields 672 of an electronic record 662 responsive to receiving a topic selection 674. For example, the electronic record 662 may have selectable subsets of the fields 672 corresponding to a set of guides. For example, FIG. 2 illustrates a user interface 200 for selecting one or more guides. In this example, the selection of the one or more guides is the topic selection 674. In some examples, the topical subset of fields 678 corresponds to one or more selected sections (e.g., tabs, flowsheets, or other subsections) of the electronic record 662.

The next fields predictor 680 identifies, in the electronic record 662, next fields 682 of the fields 672 of the electronic record 662 that are relevant to a context that involves a professional interaction. In some implementations, the next fields predictor 680 includes a predictive AI model (e.g., a predictive machine learning model) that outputs an indication of the next fields 682 responsive to input of contextual information. The contextual information may include one or more of the topical subset of fields 678, record entities 670 identified in the professional interaction, subject information 684, a professional profile 686, and historical entities 688. For example, the subject information 684 includes information about the subject of the professional interaction (e.g., that involves a professional and the subject), for example, demographic information of the subject, preferences corresponding to the subject, or other information. The professional profile 686 includes information about the professional involved in the professional interaction, for example, preferred fields of the electronic record 662 defined by the professional, a preferred order of fields in which data is entered, or other information that may affect which fields of the electronic record 662 the professional may wish to enter data in or not wish to enter data in during the professional interaction. In some implementations, in addition to or instead of the professional profile 686, the contextual data includes an institutional profile corresponding to an institution (e.g., a hospital, a bureau, or other institution), a department or other sub-institution of an institution (e.g., a sub-unit of a hospital), or other entity with which the professional is associated. For example, the institutional profile includes information about the institution, for example, preferred fields of the electronic record 662 defined by the institution, a preferred order of fields in which data is entered, or other information that may affect which fields of the electronic record 662 defined by the institution. The historical entities 688 are data that has already been entered into corresponding fields of the electronic record 662. For example, each entity is data that has been entered into a corresponding field of the electronic record 662.

The predictive AI model may be trained on contextual information and using next fields as ground truth labels. For example, the training data may include sets of training data and corresponding sets of next fields that a professional selects. During the training phase, a loss may be determined between the next fields predicted by the predictive AI model and the labels selected by the professional, and one or more weights or other parameters of the predictive AI model are modified to minimize the loss function. The loss function represents how well the next fields predictions correspond to ground truth labels. The gradient of the loss function (e.g., a vector that represents the direction rate of change) and update the parameters of the predictive AI model based on the gradient of the loss function.

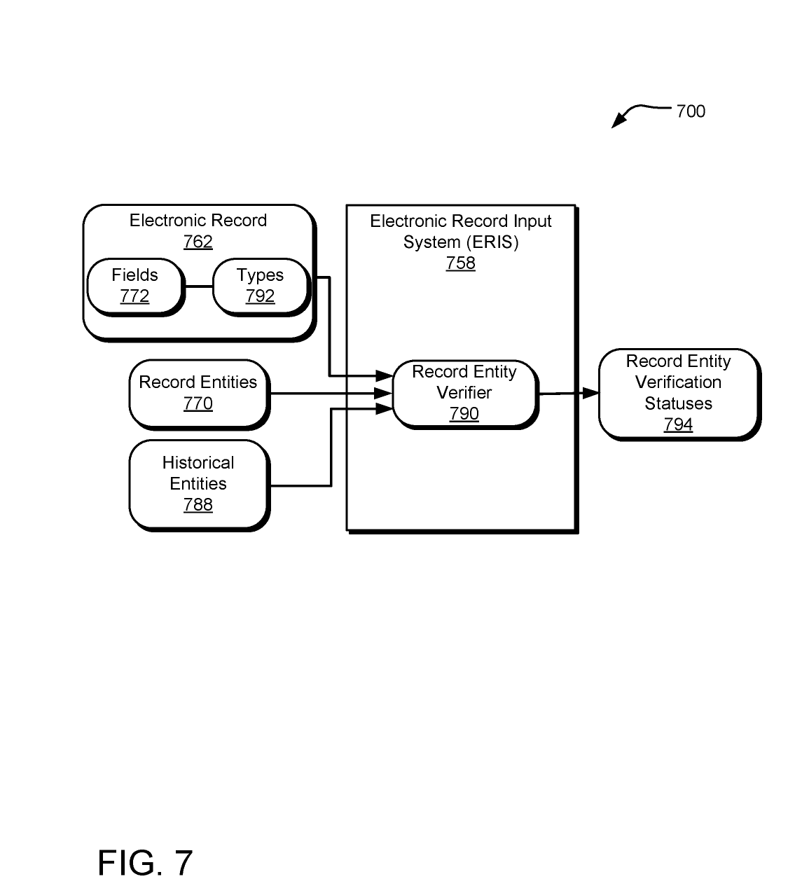

FIG. 7 illustrates an example computing environment 700 for determining record entity verification statuses 794 for record entities 770 detected during a professional interaction. The computing environment 700 includes an ERIS 758. The ERIS 758 includes a record entity verifier 790. The record entity verifier 790 determines record entity verification statuses 794 for record entities 770 detected in a professional interaction. Examples of record entity verification statuses 794 are illustrated in FIG. 3. For example, entity verification statuses 794 may include, but are not limited to, a verified entity status, a missing information entity status, information from a historical data source, and a contradicting entity status. The record entity verifier 790 may determine the record entity verification statuses 794 for the record entities 770 detected in the professional interaction based on one or more of the fields 772 of the electronic record 762, the types 792 (e.g., data input types) corresponding to the fields 772, and historical entities 788. The historical entities 788 are data that was previously input into corresponding fields 772 of the electronic record 762. For example, a historical entity is data that was input into a corresponding field of the electronic record 762.

To determine a verified status for a record entity, the record entity verifier 790 may determine a field type (e.g., types 792) corresponding to a field (e.g., fields 772) for which the record entity (e.g., record entities 770) is input data. For example, the types 792 corresponding to the fields 772 of an electronic record specify the types of input data (e.g., numeric, date/time, text, etc.) that can be entered into the fields 772. If the record entity verifier 790 determines that the field type matches the data type of the record entity, the record entity verifier 790 assigns a verified entity status to the record entity.

To determine a missing information status for a record entity, the record entity verifier 790 may identify a record entity (e.g., in a transcript of the professional interaction) that is relevant to a field (e.g., fields) in the electronic record 762 for which information has not been received, where the record entity also does not provide the missing information. For example, the entity reads “I don’t know if the patient has Alzheimer’s” and the wording of the entity indicates that the speaker has provided information that indicates an entry of a check into the “I don’t know” checkbox of the electronic record 762. Accordingly, the record entity verifier 790 determines that the entity is a missing information entity.

To determine a contradicting status for a record entity, the record entity verifier 790 may determine that a historical entity (e.g., historical entities 788) contradicts the record entity (e.g., record entities). For example, a historical entity that is entered into a field of the electronic record 762 for which the record entity is input data contradicts the record entity. If the record entity verifier 790 determines that a historical entity contradicts the record entity, the record entity verifier 790 assigns a contradicting entity status to the record entity.

In some implementations, a relevant status may be assigned to a field of the electronic record 762. To determine a relevant status for a field, the record entity verifier 790 may determine that the field of the electronic record 762 has no historical entities 788 and no record entities 770 have been detected in the professional interaction that corresponds to the field. If the record entity verifier 790 determines that the field does not correspond to a historical entity or any detected record entities, the record entity verifier 790 assigns a relevant status to the field.

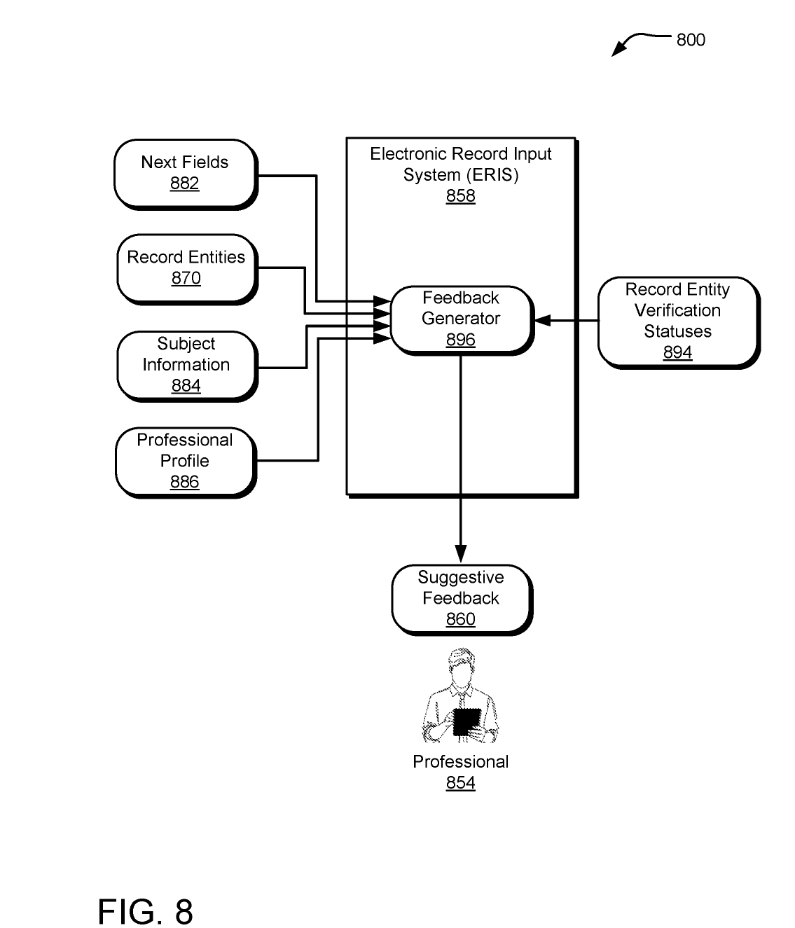

FIG. 8 illustrates an example computing environment 800 for generating suggestive feedback 860 for guiding a professional interaction. The computing environment 800 includes an ERIS 858. The ERIS 858 includes a feedback generator 896 that generates suggestive feedback 860 based on a set of contextual information, including one or more of the next fields 882, record entity verification statuses 894, record entities 870, subject information 884, or a professional profile 886. The suggestive feedback 860 is generated to guide a professional 854 in conducting the professional interaction.

For example, the next fields predictor of the ERIS 858 identifies, in an electronic record, the next fields 882 of the electronic record relevant to a context involving a professional interaction.

The record entity verification statuses 894 may include but are not limited to, a verified entity status, a missing information entity status, and a contradicting entity status. One or more of the record entities may be assigned a record entity verification status.

For example, the subject information 884 includes information about the subject of the professional interaction (e.g., that involves a professional and the subject), for example, demographic information of the subject, preferences corresponding to the subject, or other information.

The professional profile 886 includes information about the professional involved in the professional interaction, for example, a preferred format for suggestive feedback 860 or other information that may specify how suggestive feedback 860 is generated to guide the professional interaction. In some implementations, in addition to or instead of the professional profile 886, the contextual data includes an institutional profile corresponding to an institution (e.g., a hospital, a bureau, or other institution) with which the professional is associated. For example, the institutional profile includes information about the institution, for example, a preferred format for suggestive feedback 860 or other information that may specify how suggestive feedback 860 is generated to guide the professional interaction.

Some or all of the suggestive feedback 860 may include outputs of a generative AI model. The feedback generator 896 may generate inputs (e.g., a query) for the generative AI model that includes the contextual data and that requests the generation of suggestive feedback 860 and may receive the outputs of the generative AI model, the outputs including the suggestive feedback 860. The generative AI model may be a language model, such as a large language model (LLM). The suggestive feedback 860 may include one or more questions (e.g., questions to ask the subject) or suggested actions (e.g., suggested steps/tests/actions to perform) for the professional. For example, the professional may use the questions or suggested actions during the professional interaction to obtain further information for entry into the electronic record. For example, the ERIS 858 may detect (e.g., in a transcript generated from audio/video/sensor feed data of the professional interaction) further record entities during the professional interaction subsequent to the professional asking the questions in the suggestive feedback 860 to the subject and the subject providing answers to the questions. The suggestive feedback 860 may include one or more of the record entity verification statuses 894, for example, indicated in a live transcript of the professional interaction, as depicted in FIG. 3. The suggestive feedback 860 may include suggestions for improvement of an environment of the professional, for example, a suggestion to reduce noise (e.g., TV/music noise) of the environment, a suggestion to ask the subject to increase his or her volume of speaking, a suggestion to recapture a poorly captured image, or other suggestion that increases the quality of the transcription of the professional interaction.

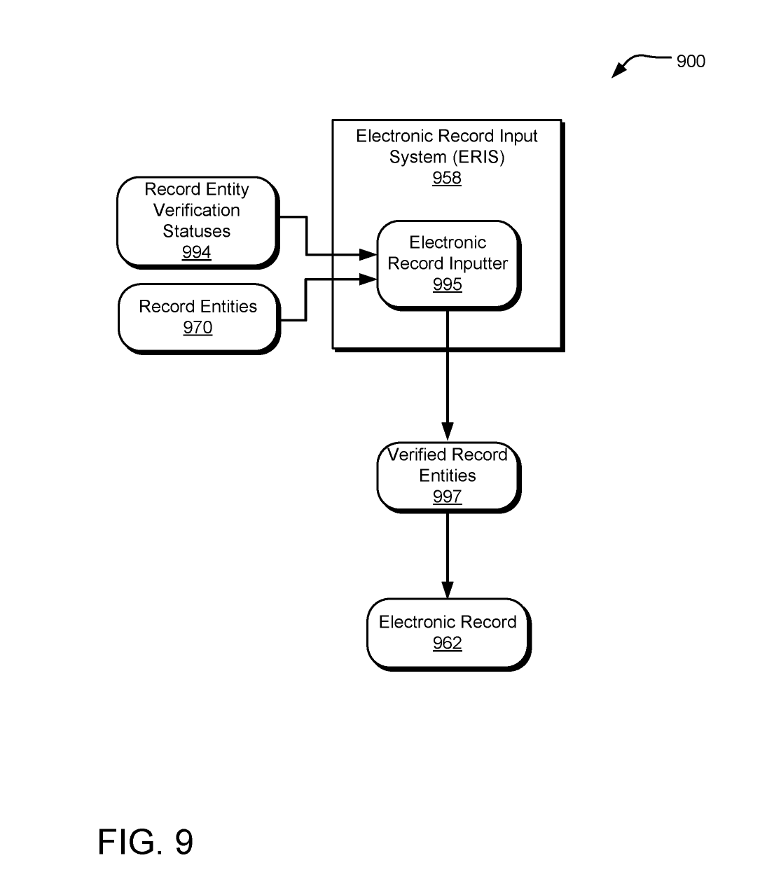

FIG. 9 illustrates an example computing environment 900 for entering verified record entities 997 into an electronic record 962. The computing environment 900 includes an ERIS 958. The ERIS 958 includes an electronic record inputter 995. In some implementations, the electronic record inputter 995 inputs verified record entities 997 of the record entities 970 detected in the professional interaction into corresponding fields of the electronic record 962 when the professional interaction is complete. For example, the professional interaction is complete when the ERIS 958 detects an input from the professional (e.g., via a user computing device of the professional). In some implementations, the electronic record inputter 995 inputs verified record entities 997 of the record entities 970 detected in the professional interaction into corresponding fields of the electronic record 962 during the professional interaction. Verified record entities correspond to record entities 970 detected in the professional interaction that correspond to “verified” statuses in the record entity verification statuses 994.

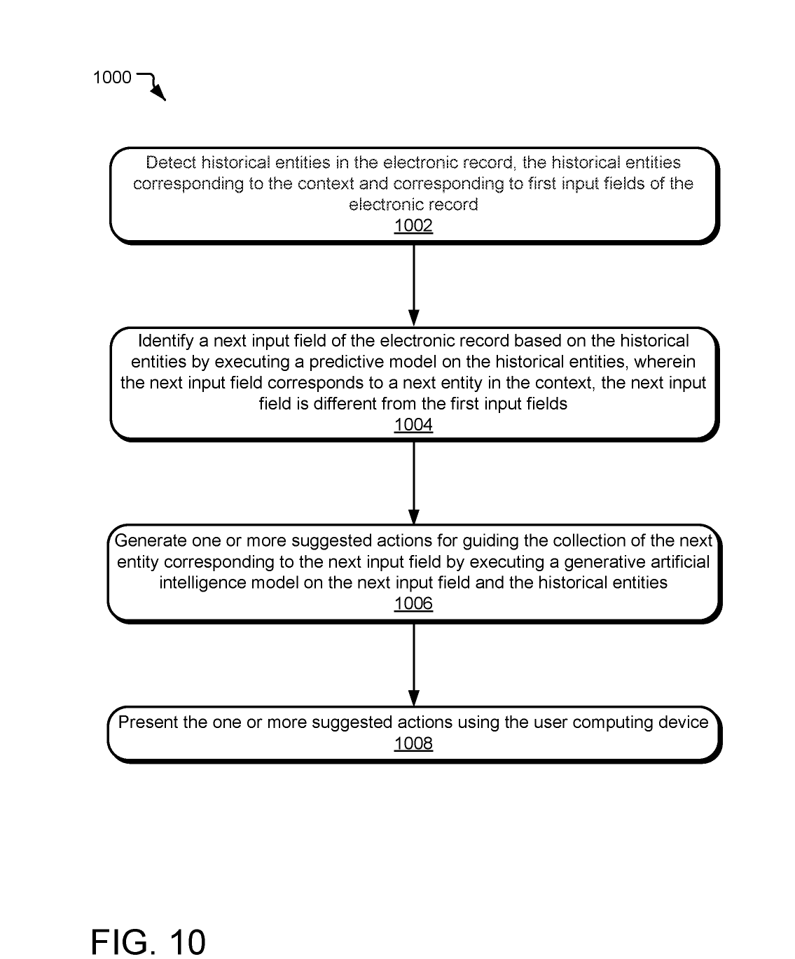

FIG. 10 depicts examples of operations 1000 for guiding collection of information for input into an electronic record via a user computing device. The example operations 1000 are, in some implementations, performed by an electronic record input system with characteristics the same or similar as described herein concerning FIG. 1-9.

An example detecting operation 1002 detects historical entities in the electronic record, the historical entities corresponding to the context and corresponding to first input fields of the electronic record.

An example identifying operation 1004 identifies a next input field of the electronic record based on the historical entities by executing a predictive model on the historical entities, wherein the next input field corresponds to a next entity in the context, the next input field is different from the first input fields. In some implementations, the predictive model is trained using a training data set including sets of historical entities and corresponding sets of next field names. In some implementations, a historical contradicting entity is identified from the historical entities, the historical contradicting entity of the historical entities and a contradicting entity of the entities corresponding to a same field of the electronic record, the historical contradicting entity being different from the contradicting entity, wherein the next entity is a resolving entity corresponding to either the historical contradicting entity or the contradicting entity. In some implementations, the contradicting entity is presented in the transcript of the subsequent natural language input.

An example generating operation 1006 generates one or more suggested actions for guiding the collection of the next entity corresponding to the next input field by executing a generative artificial intelligence model on the next input field and the historical entities. In some implementations, the collection of the next entity involves receiving a natural language input, wherein the historical entities were detected in a previous natural language input. In some implementations, the next entity is identified in the natural language input and input into the next input field of the electronic record.

An example presenting operation 1008 presents the one or more suggested actions using the user computing device. In some implementations a subsequent natural language input is received, entities are detected in the subsequent natural language input, one or more verified entities is identified from the entities, the one or more verified entities having formats corresponding to formats of one or more corresponding second fields of the electronic record, and the one or more verified entities are presented in a transcript of the subsequent natural language input using the user computing device. In some implementations, the one or more verified entities are input to the one or more corresponding second fields.

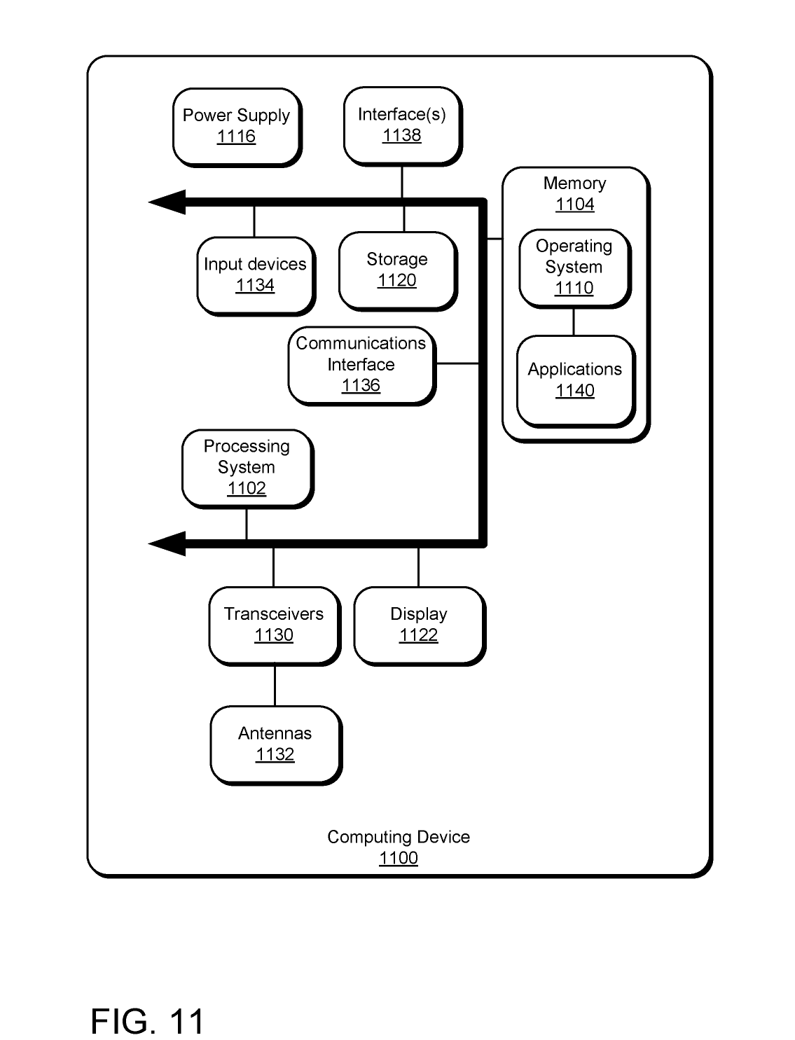

FIG. 11 illustrates an example computing device 1100 for use in implementing the described technology. The computing device 1100 may be a client computing device (such as a laptop computer, a desktop computer, or a tablet computer), a server/cloud computing device, an Internet-of-Things (IoT), any other type of computing device, or a combination of these options. The computing device 1100 includes one or more hardware processor(s) 1102 and a memory 1104. The memory 1104 generally includes volatile memory (e.g., RAM) and nonvolatile memory (e.g., flash memory), although one or the other type of memory may be omitted. An operating system 1110 resides in the memory 1104 and is executed by the processor(s) 1102. In some implementations, the computing device 1100 includes and/or is communicatively coupled to storage 1120.

In the example computing device 1100, as shown in FIG. 11, one or more software modules, segments, and/or processors, such as applications 1140, an electronic record input system (ERIS), a transcriber, a record entity identifier, a fields subset selector, a next fields predictor, a predictive model, a generative model, a record entity verifier, a feedback generator, an electronic record inputter, and other program code and modules are loaded into the operating system 1110 on the memory 1104 and/or the storage 1120 and executed by the processor(s) 1102. The storage 1120 may store an electronic record, suggestive feedback, a professional interaction (e.g., feed data including audio, video, sensor data, or other feed data recording the professional interaction), record entities, a transcript, a topic selection, fields, one or more topical subsets of fields, subject information, a professional profile, historical entities, types, record entity verification statuses, predicted next fields, verified record entities, and other data and be local to the computing device 1100 or may be remote and communicatively connected to the computing device 1100. In particular, in one implementation, components of a system for guiding the collection of information for input into an electronic record via a user computing device may be implemented entirely in hardware or in a combination of hardware circuitry and software.

The computing device 1100 includes a power supply 1116, which may include or be connected to one or more batteries or other power sources and which provides power to other components of the computing device 1100. The power supply 1116 may also be connected to an external power source that overrides or recharges the built-in batteries or other power sources.

The computing device 1100 may include one or more communication transceivers 1130, which may be connected to one or more antenna(s) 1132 to provide network connectivity (e.g., mobile phone network, Wi-Fi®, Bluetooth®) to one or more other servers, client devices, IoT devices, and other computing and communications devices. The computing device 1100 may further include a communications interface 1136 (such as a network adapter or an I/O port, which are types of communication devices). The computing device 1100 may use the adapter and any other types of communication devices for establishing connections over a wide-area network (WAN) or local-area network (LAN). It should be appreciated that the network connections shown are exemplary and that other communications devices and means for establishing a communications link between the computing device 1100 and other devices may be used.

The computing device 1100 may include one or more input devices 1134 such that a user may enter commands and information (e.g., a keyboard, trackpad, or mouse). These and other input devices may be coupled to the server by one or more interfaces 1138, such as a serial port interface, parallel port, or universal serial bus (USB). The computing device 1100 may further include a display 1122, such as a touchscreen display.

The computing device 1100 may include a variety of tangible processor-readable storage media and intangible processor-readable communication signals. Tangible processor-readable storage can be embodied by any available media that can be accessed by the computing device 1100 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 1100. In contrast to tangible processor-readable storage media, intangible processor-readable communication signals may embody processor-readable instructions, data structures, program modules, or other data resident in a modulated data signal, such as a carrier wave or other signal transport mechanism. The term "modulated data signal" means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A computer-implemented method of guiding collection of information for input into an electronic record via a user computing device, the information corresponding to a context, the computer-implemented method comprising: detecting historical entities in the electronic record, the historical entities corresponding to the context and corresponding to first input fields of the electronic record; identifying a next input field of the electronic record based on the historical entities by executing a predictive model on the historical entities, wherein the next input field corresponds to a next entity in the context, the next input field is different from the first input fields; generating one or more suggested actions for guiding the collection of the next entity corresponding to the next input field by executing a generative artificial intelligence model on the next input field and the historical entities; and presenting the one or more suggested actions using the user computing device.

Clause 2. The computer-implemented method of clause 1, wherein the collection of the next entity involves receiving a natural language input, wherein the historical entities were detected in a previous natural language input.

Clause 3. The computer-implemented method of clause 2, further comprising: identifying the next entity in the natural language input; and inputting the next entity into the next input field of the electronic record.

Clause 4. The computer-implemented method of clause 1, wherein the predictive model is trained using a training data set including sets of historical entities and corresponding sets of next field names.

Clause 5. The computer-implemented method of clause 1, further comprising: receiving a subsequent natural language input; detecting entities in the subsequent natural language input; identifying, from the entities, one or more verified entities, the one or more verified entities having formats corresponding to formats of one or more corresponding second fields of the electronic record; and presenting the one or more verified entities in a transcript of the subsequent natural language input using the user computing device.

Clause 6. The computer-implemented method of clause 5, further comprising: inputting the one or more verified entities to the one or more corresponding second fields.

Clause 7. The computer-implemented method of clause 5, further comprising: identifying a historical contradicting entity from the historical entities, the historical contradicting entity of the historical entities and a contradicting entity of the entities corresponding to a same field of the electronic record, the historical contradicting entity being different from the contradicting entity, wherein the next entity is a resolving entity corresponding to either the historical contradicting entity or the contradicting entity.

Clause 8. The computer-implemented method of clause 7, further comprising: presenting the contradicting entity in the transcript of the subsequent natural language input.

Clause 9. A system for guiding collection of information for input into an electronic record via a user computing device, the information corresponding to a context, the system comprising: one or more hardware processors; a memory; a record entity identifier storable in the memory, executable by the one or more hardware processors, and configured to perform operations comprising detecting historical entities in the electronic record, the historical entities corresponding to the context and corresponding to first input fields of the electronic record; a next fields predictor storable in the memory, executable by the one or more hardware processors, and configured to perform operations comprising identifying a next input field of the electronic record based on the historical entities by executing a predictive model on the historical entities, wherein the next input field corresponds to a next entity in the context, the next input field is different from the first input fields; and a feedback generator storable in the memory, executable by the one or more hardware processors, and configured to perform operations comprising: generating one or more suggested actions for guiding the collection of the next entity corresponding to the next input field by executing a generative artificial intelligence model on the next input field and the historical entities; and presenting the one or more suggested actions using the user computing device.

Clause 10. The system of clause 9, wherein the collection of the next entity involves receiving a natural language input, wherein the historical entities were detected in a previous natural language input.

Clause 11. The system of clause 10, wherein the record entity identifier is further configured to identify the next entity in the natural language input, the system further comprising an electronic record inputter storable in the memory, executable by the one or more hardware processors, and configured to perform operations comprising the next entity into the next input field of the electronic record.

Clause 12. The system of clause 9, wherein the predictive model is trained using a training data set including sets of historical entities and corresponding sets of next field names.

Clause 13. The system of clause 9, further comprising: a transcriber storable in the memory, executable by the one or more hardware processors, and configured to perform operations comprising receiving a subsequent natural language input, wherein the record entity identifier is further configured to detect entities in the subsequent natural language input; and a record entity verifier storable in the memory, executable by the one or more hardware processors, and configured to perform operations comprising identifying, from the entities, one or more verified entities, the one or more verified entities having formats corresponding to formats of one or more corresponding second fields of the electronic record, wherein the feedback generator is further configured to present the one or more verified entities in a transcript of the subsequent natural language input using the user computing device.

Clause 14. The system of clause 13, further comprising an electronic record inputter storable in the memory, executable by the one or more hardware processors, and configured to perform operations comprising entering the one or more verified entities to the one or more corresponding second fields.

Clause 15. One or more tangible processor-readable storage media embodied with instructions for executing on one or more processors and circuits of a computing device a process for guiding collection of information for input into an electronic record via a user computing device, the information corresponding to a context, the process comprising: detecting historical entities in the electronic record, the historical entities corresponding to the context and corresponding to first input fields of the electronic record; identifying a next input field of the electronic record based on the historical entities by executing a predictive model on the historical entities, wherein the next input field corresponds to a next entity in the context, the next input field is different from the first input fields; generating one or more suggested actions for guiding the collection of the next entity corresponding to the next input field by executing a generative artificial intelligence model on the next input field and the historical entities; and presenting the one or more suggested actions using the user computing device.

Clause 16. The one or more tangible processor-readable storage media of clause 15, wherein the collection of the next entity involves receiving a natural language input, wherein the historical entities were detected in a previous natural language input.

Clause 17. The one or more tangible processor-readable storage media of clause 16, the process further comprising: identifying the next entity in the natural language input; and inputting the next entity into the next input field of the electronic record.

Clause 18. The one or more tangible processor-readable storage media of clause 15, wherein the predictive model is trained using a training data set including sets of historical entities and corresponding sets of next field names.

Clause 19. The one or more tangible processor-readable storage media of clause 18, the process further comprising: receiving a subsequent natural language input; detecting entities in the subsequent natural language input; identifying, from the entities, one or more verified entities, the one or more verified entities having formats corresponding to formats of one or more corresponding second fields of the electronic record; and presenting the one or more verified entities in a transcript of the subsequent natural language input using the user computing device.

Clause 20. The one or more tangible processor-readable storage media of clause 19, the process further comprising inputting the one or more verified entities to the one or more corresponding second fields.

Clause 21. A system of guiding collection of information for input into an electronic record via a user computing device, the information corresponding to a context, the system comprising: means for detecting historical entities in the electronic record, the historical entities corresponding to the context and corresponding to first input fields of the electronic record; means for identifying a next input field of the electronic record based on the historical entities by executing a predictive model on the historical entities, wherein the next input field corresponds to a next entity in the context, the next input field is different from the first input fields; generating one or more suggested actions for guiding the collection of the next entity corresponding to the next input field by executing a generative artificial intelligence model on the next input field and the historical entities; and means for presenting the one or more suggested actions using the user computing device.

Clause 22. The system of clause 21, wherein the collection of the next entity involves receiving a natural language input, wherein the historical entities were detected in a previous natural language input.

Clause 23. The system of clause 22, further comprising: means for identifying the next entity in the natural language input; and means for inputting the next entity into the next input field of the electronic record.

Clause 24. The system of clause 21, wherein the predictive model is trained using a training data set including sets of historical entities and corresponding sets of next field names.

Clause 25. The system of clause 21, further comprising: means for receiving a subsequent natural language input; detecting entities in the subsequent natural language input; means for identifying, from the entities, one or more verified entities, the one or more verified entities having formats corresponding to formats of one or more corresponding second fields of the electronic record; and means for presenting the one or more verified entities in a transcript of the subsequent natural language input using the user computing device.

Clause 26. The system of clause 25, further comprising: means for inputting the one or more verified entities to the one or more corresponding second fields.

Clause 27. The system of clause 25, further comprising: means for identifying a historical contradicting entity from the historical entities, the historical contradicting entity of the historical entities and a contradicting entity of the entities corresponding to a same field of the electronic record, the historical contradicting entity being different from the contradicting entity, wherein the next entity is a resolving entity corresponding to either the historical contradicting entity or the contradicting entity.

Clause 28. The system of clause 27, further comprising: means for presenting the contradicting entity in the transcript of the subsequent natural language input.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computer-implemented method of guiding collection of information for input into an electronic record via a user computing device, the information corresponding to a context, the computer-implemented method comprising:
detecting historical entities in the electronic record, the historical entities corresponding to the context and corresponding to first input fields of the electronic record;
identifying a next input field of the electronic record based on the historical entities by executing a predictive model on the historical entities, wherein the next input field corresponds to a next entity in the context, the next input field is different from the first input fields;
generating one or more suggested actions for guiding the collection of the next entity corresponding to the next input field by executing a generative artificial intelligence model on the next input field and the historical entities; and
presenting the one or more suggested actions using the user computing device.

2. The computer-implemented method of claim 1, wherein the collection of the next entity involves receiving a natural language input, wherein the historical entities were detected in a previous natural language input.

3. The computer-implemented method of claim 2, further comprising:
identifying the next entity in the natural language input; and
inputting the next entity into the next input field of the electronic record.

4. The computer-implemented method of claim 1, wherein the predictive model is trained using a training data set including sets of historical entities and corresponding sets of next field names.

5. The computer-implemented method of claim 1, further comprising:
receiving a subsequent natural language input;
detecting entities in the subsequent natural language input;
identifying, from the entities, one or more verified entities, the one or more verified entities having formats corresponding to formats of one or more corresponding second fields of the electronic record; and
presenting the one or more verified entities in a transcript of the subsequent natural language input using the user computing device.

6. The computer-implemented method of claim 5, further comprising:
inputting the one or more verified entities to the one or more corresponding second fields.

7. The computer-implemented method of claim 5, further comprising:
identifying a historical contradicting entity from the historical entities, the historical contradicting entity of the historical entities and a contradicting entity of the entities corresponding to a same field of the electronic record, the historical contradicting entity being different from the contradicting entity,
wherein the next entity is a resolving entity corresponding to either the historical contradicting entity or the contradicting entity.

8. The computer-implemented method of claim 7, further comprising:
presenting the contradicting entity in the transcript of the subsequent natural language input.

9. A system for guiding collection of information for input into an electronic record via a user computing device, the information corresponding to a context, the system comprising:
one or more hardware processors;
a memory;
a record entity identifier storable in the memory, executable by the one or more hardware processors, and configured to perform operations comprising detecting historical entities in the electronic record, the historical entities corresponding to the context and corresponding to first input fields of the electronic record;
a next fields predictor storable in the memory, executable by the one or more hardware processors, and configured to perform operations comprising identifying a next input field of the electronic record based on the historical entities by executing a predictive model on the historical entities, wherein the next input field corresponds to a next entity in the context, the next input field is different from the first input fields; and
a feedback generator storable in the memory, executable by the one or more hardware processors, and configured to perform operations comprising:
generating one or more suggested actions for guiding the collection of the next entity corresponding to the next input field by executing a generative artificial intelligence model on the next input field and the historical entities; and
presenting the one or more suggested actions using the user computing device.

10. The system of claim 9, wherein the collection of the next entity involves receiving a natural language input, wherein the historical entities were detected in a previous natural language input.

11. The system of claim 10, wherein the record entity identifier is further configured to identify the next entity in the natural language input, the system further comprising an electronic record inputter storable in the memory, executable by the one or more hardware processors, and configured to perform operations comprising the next entity into the next input field of the electronic record.

12. The system of claim 9, wherein the predictive model is trained using a training data set including sets of historical entities and corresponding sets of next field names.

13. The system of claim 9, further comprising:
a transcriber storable in the memory, executable by the one or more hardware processors, and configured to perform operations comprising receiving a subsequent natural language input,
wherein the record entity identifier is further configured to detect entities in the subsequent natural language input; and
a record entity verifier storable in the memory, executable by the one or more hardware processors, and configured to perform operations comprising identifying, from the entities, one or more verified entities, the one or more verified entities having formats corresponding to formats of one or more corresponding second fields of the electronic record,
wherein the feedback generator is further configured to present the one or more verified entities in a transcript of the subsequent natural language input using the user computing device.

14. The system of claim 13, further comprising an electronic record inputter storable in the memory, executable by the one or more hardware processors, and configured to perform operations comprising entering the one or more verified entities to the one or more corresponding second fields.

15. One or more tangible processor-readable storage media embodied with instructions for executing on one or more processors and circuits of a computing device a process for guiding collection of information for input into an electronic record via a user computing device, the information corresponding to a context, the process comprising:
detecting historical entities in the electronic record, the historical entities corresponding to the context and corresponding to first input fields of the electronic record;
identifying a next input field of the electronic record based on the historical entities by executing a predictive model on the historical entities, wherein the next input field corresponds to a next entity in the context, the next input field is different from the first input fields;
generating one or more suggested actions for guiding the collection of the next entity corresponding to the next input field by executing a generative artificial intelligence model on the next input field and the historical entities; and
presenting the one or more suggested actions using the user computing device.

16. The one or more tangible processor-readable storage media of claim 15, wherein the collection of the next entity involves receiving a natural language input, wherein the historical entities were detected in a previous natural language input.

17. The one or more tangible processor-readable storage media of claim 16, the process further comprising:
identifying the next entity in the natural language input; and
inputting the next entity into the next input field of the electronic record.

18. The one or more tangible processor-readable storage media of claim 15, wherein the predictive model is trained using a training data set including sets of historical entities and corresponding sets of next field names.

19. The one or more tangible processor-readable storage media of claim 18, the process further comprising:
receiving a subsequent natural language input;
detecting entities in the subsequent natural language input;
identifying, from the entities, one or more verified entities, the one or more verified entities having formats corresponding to formats of one or more corresponding second fields of the electronic record; and
presenting the one or more verified entities in a transcript of the subsequent natural language input using the user computing device.

20. The one or more tangible processor-readable storage media of claim 19, the process further comprising inputting the one or more verified entities to the one or more corresponding second fields.
